(19) United States
(12) Patent Application Publication
(10) Pub. No.: US 2008/0016533 A1
(43) Pub. Date: Jan. 17, 2008

(54) Device, system and method for delivering digital media content to a user

(76) Inventor: Leigh M. Rothschild, Plantation, FL (US)

Correspondence Address: CASELLA & HESPOS, 274 MADISON AVENUE, NEW YORK, NY, 10016, US

(21) Appl. No.: 11/270,265

(22) Filed: Nov. 9, 2005

(51) Int. Cl. H04N 5/445; H04N 7/16

(52) U.S. Cl. 725/60; 725/61; 725/87; 725/86; 725/62

(57) ABSTRACT

A device, system and method for delivering media content to a user are provided. The present disclosure utilizes push technology to send media content, e.g., audio, video, photos, etc., to a user without the user requesting the media content. The method includes the steps receiving a first request for at least one selection of media content; selecting at least one second selection of media content based a profile of the user; and transmitting to the user the at least one selection of media content and the at least one second selection of media content, wherein a portion of the at least one second selection of media content is locked to prevent user access and includes a preview of the locked portion. The method further includes the step charging a transaction fee to an account of the user for unlocking the second selection of the media content.

### BACKGROUND OF THE INVENTION

1. Field of the Invention

The present disclosure relates generally to digital media content systems, and more particularly, to devices, systems and methods for delivering or pushing digital media content to a user.

2. Description of the Related Art

Digital media playback devices are everywhere. Creative Labs, Inc. of Milpitas, Calif. produced one of the first portable digital playback devices allowing the user to playback MP3 content, i.e., digital audio content, on the go. Apple Computers, Inc. of Cupertino, Calif. has had a huge success in producing the iPod™ media players and iriver™ of Vancouver, Wash. produces both portable digital audio and digital video players.

Current digital media players hold the digital media in memory storage. Some devices feature removable memory and some feature internal memory. The trend in media players has increasingly been to provide as much digital storage as possible, thereby increasing media content capacity. In the last few years, memory capacity on portable devices has dramatically expanded. For example, the iPod™ started by offering 10 GB of storage and the largest model currently offers 60 GB. Of course, as more digital storage is offered, the more media content can be available for the user.

Current digital media players allow the user to link and synchronize the media players to their computers and then transfer media content from the computer to the portable media device. The user selects the preferred media from either a local or remote computer and then downloads that media to the media device. The media can then be played on the portable device.

An important marketing trend that is currently used for targeting consumers is product profiling. This means that a marketer analyzes what products a consumer has previously purchased and also considers other psychographic and demographic information, and then based on all this information suggest products that the user may want to purchase. For example, Internet book retailer Amazon.com uses buyer profiles to suggest products to their customers. Product profiling allows a seller to sell the customer more products then the customer might have purchased on his own.

Still another trend in portable media devices is to allow them to communicate using various communications techniques. For instance, Motorola has recently introduced a device that allows the user to make phone calls with an integrated iPod™ capable device (i.e., the ROKR model commercially available from Cingular Wireless). Several Pocket PC devices can connect to the Internet using cellular modems or WiFi communications and will also play various types of media. Archos, Inc. of Irvine, Calif. recently showed a WiFi enabled media device (i.e., the model PMA400) that is Linux-based. Another trend for portable media devices will be to incorporate broadcast tuners to receive broadcasts (e.g., from Am and FM radio stations) and storage mediums to store these broadcasts, such as the iFP-100 series of portable players from iriver™.

In light of the above, a need exists for techniques to allow a publisher or distributor of digital media content to push various media content to users to exposed users to such media content. A further need exists for techniques to place locked digital media content including audio, video and images onto a digital media hardware playback device, to allow the user to preview this media content and, if the user elects, then to pay the publisher for the media content (or to agree to pay the publisher for the media) and to playback the media content.

### SUMMARY OF THE INVENTION

A device, system and method for delivering media content to a user are provided. The present disclosure utilizes push technology to send media content, e.g., audio, video, photos, etc., to a user without the user requesting the media content. The present disclosure details a system and method for a remote server (e.g., a media publisher or distributor) to use market profiling to suggest media that the user may be interested in, place that media on the user's media device, allow the user to preview the media and, if the user elects, purchase and playback the media.

In one embodiment of the present disclosure, a user will utilize a portable media playback device with wireless connectivity capabilities. The user will download or receive by broadcast (e.g., satellite or conventional broadcast channels) music or video from a website or transmitter provided by a music publisher. The publisher could additionally download or transmit by broadcasting (via satellite or conventional broadcast channels) locked/encrypted music or video or other digital content along with previews of that content. The publisher will decide which content to download or transmit by utilizing market profiling. The user will be able to unlock this content wirelessly while using the portable media playback device. As the content is unlocked, the publisher would receive compensation for the unlocked media content in a standard e-commerce transaction.

In another embodiment of the present disclosure, the user will utilize a hardware device with wired connectivity. The user will download or receive by broadcast (satellite or conventional broadcast channels) music or video from a website or transmitter provided by the music publisher. The publisher will also download or transmit by broadcast (satellite or conventional broadcast channels) locked/encrypted music or video or other digital content and previews of that content. The publisher will decide which content to download or transmit by utilizing user profiling. The user will be able to unlock this content while using the portable device. The user will tell the hardware device via an interface, or input module, which media content the user wishes to unlock. The device will then store this unlock information and release the digital content. When the user next connects to the publisher's website, the hardware device will transmit to the publisher information as to which media content has been unlocked and the publisher would receive compensation for the unlocked media in a standard e-commerce transaction.

According to one aspect of the present disclosure, a method for delivering media content to a user over a computer network includes the steps receiving a first request for at least one selection of media content; selecting at least one second selection of media content based a profile of the user; and transmitting to the user the at least one selection of media content and the at least one second selection of media content, wherein a portion of the at least one second selection of media content is locked to prevent user access. The method further includes the steps receiving a second request to view the locked portion of the at least one second selection of media content; transmitting to the user a code for unlocking the locked portion of the at least one second selection of media content and charging a transaction fee to an account of the user for unlocking the at least one second selection of the media content.

In another aspect, a method of delivering media content to a user over a computer network includes the steps broadcasting at least one selection of media content over a broadcast channel, a portion of the at least one selection is locked to prevent user access; receiving a request to access at the locked portion of the at least one selection of media content; transmitting a code for unlocking the locked portion of the at least one selection of media content; and charging a transaction fee to an account of the user for unlocking the at least one selection.

In a further aspect of the present disclosure, a device for playing media content is provided. The device includes a display module configured to display video and image media content and to produce audio media content; a communication module configured to receive at least one selection of media content, a portion of the at least one selection is locked to prevent user access; an input module configured to input user instructions to indicate a request to access the locked media content; and a processing module configured for receiving the user instructions and for unlocking the locked media content.

In another aspect of the present disclosure, a system for delivering media content to a user includes at least one device for playing media content including a display module configured to display video and image media content and to produce audio media content; a communication module configured to transmit a first request for at least one selection of media content to a server; and a processing module configured for playing the at least one selection of media content; the server configured for receiving the first request for at least one selection of media content, selecting at least one second selection of media content based a profile of the user and transmitting to the at least one device the at least one selection of media content and the at least one second selection of media content, wherein a portion of the at least one second selection of media content is locked to prevent user access; and a communications network for coupling the at least one device to the server.

In yet another aspect of the present disclosure, a method for delivering media content to at least one device over a computer network includes the steps receiving a first request for at least one selection of media content; selecting at least one second selection of media content; and transmitting to the at least one device the at least one selection of media content and the at least one second selection of media content. The method further provides wherein the selecting the at least one second selection of media content is based on a profile of a user of the at least one device. The user profile includes at least psychographics, demographics, and past purchase/usage habits of the user.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is front view of a device for playing media content according to an embodiment of the present disclosure;

FIG. 2 is a block diagram of various modules included in the device illustrated in FIG. 1;

FIG. 3 illustrates a system for delivering media content to a user;

FIG. 4 is a flow diagram illustrating a method for delivering media content to a user according to an embodiment of the present disclosure; and

FIG. 5 is a flow diagram illustrating a method for delivering media content to a user according to another embodiment of the present disclosure.

### DETAILED DESCRIPTION OF THE PREFERRED EMBODIMENTS

Preferred embodiments of the present disclosure will be described hereinbelow with reference to the accompanying drawings. In the following description, well-known functions or constructions are not described in detail to avoid obscuring the present disclosure in unnecessary detail.

A device, system and method for delivering media content to a user are provided. The present disclosure utilizes push technology to send media content, e.g., audio, video, photos, etc., to a user without the user requesting the media content. The present disclosure details a system and method for a remote server, e.g., a media publisher or distributor, to use market profiling to suggest media that the user may be interested in, place that media on the user's media device, allow the user to preview the media and, if the user elects, purchase and playback the media. Alternatively, the suggested media will not be based on a user profile but will be media content the remote server, e.g., a media publisher or distributor, wants the public to be exposed to.

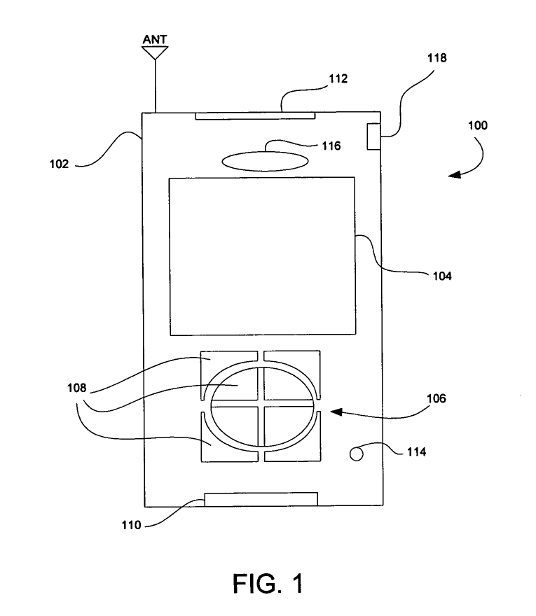

Referring to FIG. 1, a portable media playback device 100 for receiving and playing various types of digital media content, e.g., audio, video, images, etc., in accordance with an embodiment of the present disclosure is illustrated. The media device 100 includes various electrical components, which will be described in detail below, disposed in a generally rectangular housing 102. A display module 104 is provided for displaying video and image media content, such as movies, animations, etc. and a speaker 116 is provided configured to produce audio, e.g., music or a soundtrack associated with a video. An audio port 118 will be configured to receive a plug or connector from a headphone, stereo system, etc. to stream the audio to the connected device. It is to be appreciated that when an external device is connected to the audio port 118 the speaker 116 will be disabled. Input module 106 includes a plurality of buttons 108 for inputting data and navigating through a plurality of menus. A touch screen overlaid upon the display module 104 may also be coupled to the input module for facilitating user input. The media device 100 further includes a storage module 110 for storing a plurality of content and a communications module 112 for transmitting/receiving data and/or content to another device, e.g., a personal computer, a personal digital assistant (PDA), a server residing on the Internet, etc. Optionally, the media device 100 may include a microphone 114 for acquiring audio from the user of the device to input data.

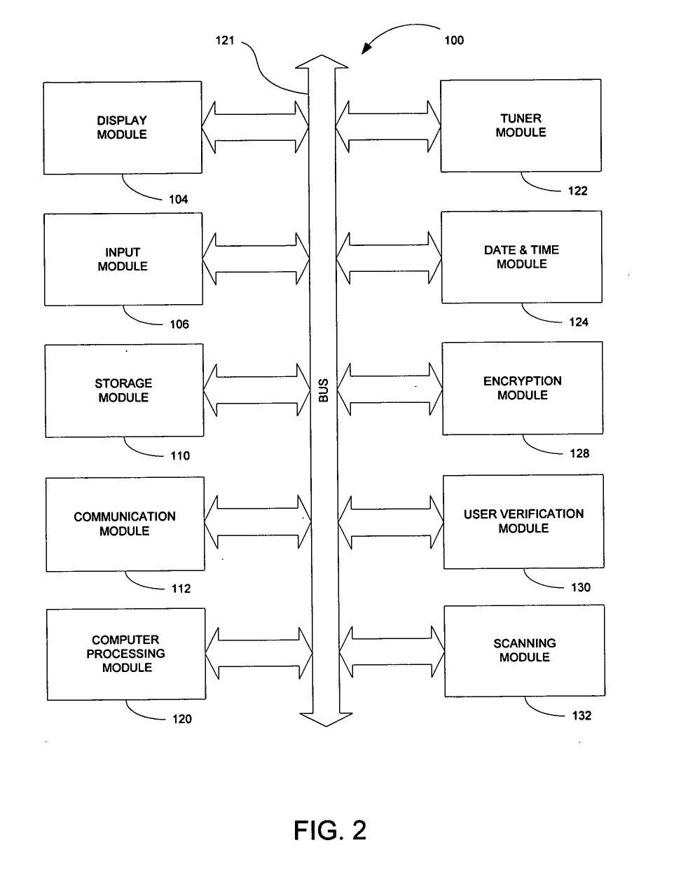

Referring to FIG. 2, the various components of the device 100 will now be described. The device will contain a computer processing module 120, e.g., a microprocessor. The computer processing module 120 will use computer software instructions that have been programmed into the module and conventional computer processing power to interact and organize the traffic flow between the various other modules. It is to be understood that the present disclosure may be implemented in various forms of hardware, software, firmware, special purpose processors, or a combination thereof. A system bus 121 couples the various components shown in FIG. 2 and may be any of several types of bus structures including a memory bus or memory controller, a peripheral bus, and a local bus using any of a variety of bus architectures. The device also includes an operating system and micro instruction code preferably residing in read only memory (ROM) (not shown). The various processes and functions described herein may either be part of the micro instruction code or part of an application program (or a combination thereof) which is executed via the operating system.

It is to be further understood that because some of the constituent device components and method steps depicted in the accompanying figures may be implemented in software, the actual connections between the device components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The computer processing module 120 may further include, in addition to a microprocessor, a digital signal processor (DSP) for decoding stored audio, video and photo files to be played on the media device 100. As is known in the art, the DSP may include several known decompression algorithms for decompressing stored media content, e.g., a MP3 file. The device 100 of the present disclosure will support various file types including but not limited to Microsoft Windows Media Video files (.wmv), Microsoft Photo Story files (.asf), Microsoft Windows Media Audio files (.wma), MP3 audio files (.mp3), JPEG image files (.jpg, .jpeg, .jpe, .jfif), MPEG movie files (.mpeg, .mpg, .mpe, .m1v, .mp2v .mpeg2), Microsoft Recorded TV Show files (.dvr-ms), Microsoft Windows Video files (.avi) and Microsoft Windows Audio files (.wav).

The device 100 will also contain a display module 104 for displaying digital information such as video files, image files, etc. This display may be in any current form in the art, including Liquid Crystal Displays (LCD), Light emitting diode displays (LED), Cathode Ray Tube Displays (CRT) or any other type of display currently existing or existing in the future. The display module 104 may also include an audio output device, e.g., a speaker 116, audio port 118, etc., allowing the user to also hear audio output from the device 100, e.g., audio associated with a video, a MP3 file, etc.

The device 100 of the present disclosure will contain a user input module 106 to either receive user instructions via text input by the way of buttons 108, a standard keyboard interface coupled to the device, or a character recognition capture device which translates user text input into alphanumeric characters. Preferably, the character recognition device is a touch screen which overlays the display module 104 and text is entered via a pen-like stylus. Such input devices are standard and currently available on many electronic devices including portable digital assistants (PDAs) and cellular telephones. Optionally, microphone 114 may be further coupled to the input module 106 for capturing any audio information spoken by the user and the input module will further include an analog-to-digital (A/D) converter for converting the spoken audio information into a digital format. Furthermore, the input module may include a voice recognition processor that translates the digital human voice into alpha numeric characters for user input. The user will utilize the user input module 106 to enter various data, for example, to enter payment information, to initiate communication with a remote server, to flag desired content to be downloaded, to request an initial selection of media content to be downloaded, etc.

The storage module 110 includes internal storage memory, e.g., random access memory (RAM), or removable memory such as magnetic storage memory; optical storage memory, e.g., the various known types of CD and DVD media; solid-state storage memory, e.g., a CompactFlash card, a Memory Stick, SmartMedia card, MultiMediaCard (MMC), SD (Secure Digital) memory; or any other memory storage that exists currently or will exist in the future.

The communication module 112 will enable the device 100 to transmit or transfer information, e.g., payment information, a flag indicating desired media to unlock, etc., to other computing devices and to receive information from other computing devices, e.g., digital media files, codes to unlock downloaded media, encryption/decryption keys, etc. The communication module 112 will perform its functionality by hardwired and/or wireless connectivity. The hardwire connection may include but is not limited to hard wire cabling e.g., parallel or serial cables, USB cable, Firewire (1394 connectivity) cables, and the appropriate port. The wireless connection will operate under any of the various known wireless protocols including but not limited to Bluetooth™ interconnectivity, infrared connectivity, radio transmission connectivity including computer digital signal broadcasting and reception commonly referred to as Wi-Fi or 802.11.X (where x denotes the type of transmission), satellite transmission or any other type of communication protocols or systems currently existing or to be developed for wirelessly transmitting data. The communication module will compress and encode the encrypted information for transmission using any known wireless communication technology.

The device 100 will also include an encryption module 128. The encryption module 128 will use conventional code encryption algorithms currently in use or that will be in use in the future such as symmetric-key algorithms, e.g., DES, Triple-DES, Blowfish, RC2, RC4, RC5, etc, and asymmetric-key algorithms, e.g., Diffie-Hellman, RSA, EIGamal, etc. to decrypt locked digital media content files that are stored in the storage module 110. The encryption module 128 may also encrypt payment information of a user before the payment information is transmitted via the communications module 112.

Furthermore, the device 100 will include a date and time module 124. The date and time module 124 will use standard computer chip processing technology widely in use, e.g., a crystal, or alternatively, input from a GPS receiver to supply the date and time.

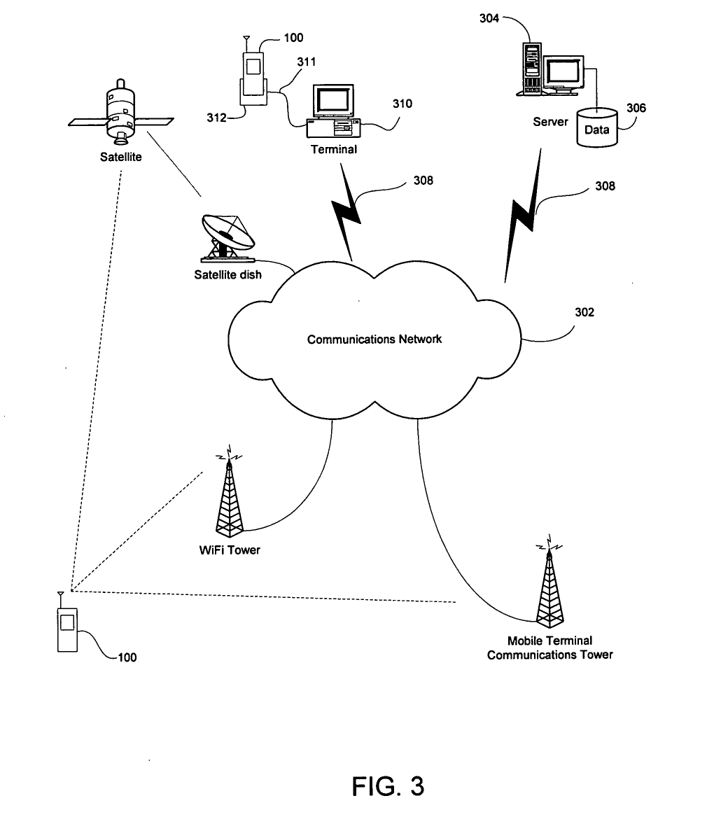

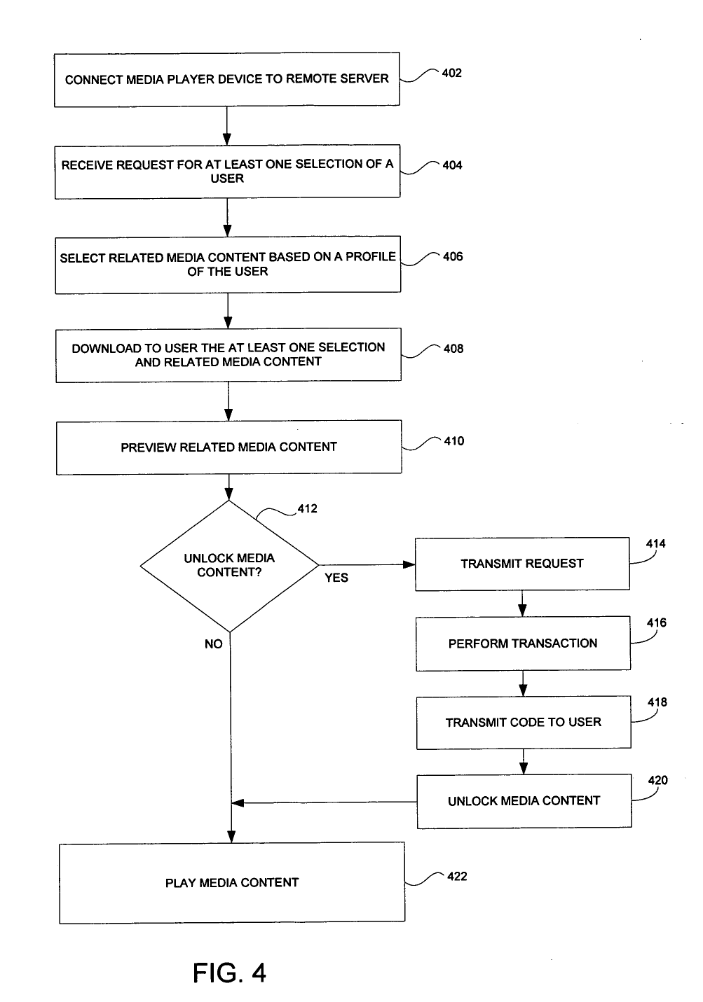

A system and method for delivering media content to a user over a network will be described in relation to FIGS. 3 and 4. Initially, the device 100 will be coupled to a terminal 310, e.g., a personal computer, via a cable 311, cradle 312, wireless connection, etc. The terminal 310 will communicate to a central server 304 via a communication network 302. The terminal 310 and server 304 may be connected to the communications network 302, e.g., the Internet, by any known means, for example, a hardwired or wireless connection 308, such as dial-up, hardwired, cable, DSL, satellite, cellular, PCS, wireless transmission (e.g., 802.11a/b/g), etc. It is to be appreciated that the network 302 may be a local area network (LAN), wide area network (WAN), the Internet or any known network that couples a plurality of computers to enable various modes of communication via network messages. Furthermore, the server 304 will communicate using the various known protocols such as Transmission Control Protocol/Internet Protocol (TCP/IP), File Transfer Protocol (FTP), Hypertext Transfer Protocol (HTTP), etc. and secure protocols such as Internet Protocol Security Protocol (IPSec), Point-to-Point Tunneling Protocol (PPTP), Secure Sockets Layer (SSL) Protocol, etc. The server 304 will further include a storage medium 306 for storing a repository of digital media content and a database of user accounts.

Referring to FIG. 4, a user connects the media player device 100 to a local processor assembly, e.g., terminal 310, to download media content via wireless or wired communications protocols from a remote storage medium 306 of remote server 304 on the global computer network, e.g., the Internet, to the device 100 (step 402). When the user is connected to a remote server site (e.g., a website residing on remote server 304), the user will be able to select various types of media content to be downloaded to the device 100, e.g., movies, music, computer games, etc. Once the selections are made by the user, a request will be sent to the remote server 304 for processing (step 404). Once the server 304 receives the request from the user, the server will select related media content (e.g., at least one second selection) to be delivered to the user based on a profile of the user (step 406). This selection of media content will be based on profiling the user to determine which media content the user might be interested in. Factors such as the demographics (e.g., age, gender, etc.) and psychographics (e.g., opinions on various subject matter, personality traits, music tastes, etc.) of the user, and previous media purchases of the user, as well as previous media that the user has played on the device, as well as media that the user has requested to be downloaded when available (such as by actor or artist, or director, or composer), as well as media that the publisher wants the user to be exposed to, would all be determinative of which media the publisher downloads to the hardware device. Upon the users request, the publisher/distributor would also be able to download media that the publisher thinks the user is interested in (such as sequels to previously purchased products) and/or media content the publisher/distributor wants the user to be exposed to without the user profile being the determinative factor. The profile of the user may be derived from information entered by the user when creating an account to purchase the media content (e.g., age, residence, etc.) or possibly from a questionnaire or survey presented to the user during a previous transaction, for example, musical tastes, desired types of movies, favorite artists, etc.

Once the related selections are determined, a publisher or distributor of the media (such as iTunes, Rhapsody or Napster) would then download media content that the user has selected and the related media content to the internal or removable digital storage module 110 of the device 100 (step 408). Once the user has received this digital media content, the user would be able to preview the related media content by using basic player software that is built into the digital player device (step 410). Such music software currently includes the Apple iPod player software, as well as the Microsoft Media Player software. Of course any type of music player software may be used in the future. Video player software includes RealPlayer by Real Networks, Quick Time by Apple Computers, and Microsoft Media Player. Again, any type of video player software may be used in the future. This media player software is powered by the computer processor module 120 and/or DSP contained within the device 100.

A portion of the related media content will be locked to prevent user access. The unlocked or available portion may be a preview of the related media content, a trailer of related the media content, the first few minutes of the related media content, etc.

After previewing the media content delivered, the user will decide if they desire to unlock the locked portion of the related media content and have access to the whole file (step 412). When the user wishes to play the locked media, he will inform the processing module 120 via input module 106 that he wishes to access this media content. The processing module 120 will then inform the communication module 112 of the device to transmit a request to the remote server 304 to allow the user to unlock the digital media content (step 414). The communication module 112 may connect to the communications network 302 by any known communication means includes WiFi connectivity via a WiFi tower (e.g., of various types including 802.11a/b/g), infrared connectivity, satellite communications, radio frequency, a mobile terminal communications tower, e.g., cellular, PCS, etc. to transmit this request.

The locked digital media may be encrypted with any type of current encryption algorithms including Blowfish, DES, Cast, or any type of Digital rights Management software including Digital Rights Management software currently offered by Microsoft Corporation of Redmond, Wash. Therefore, the device will need a code or encryption/decryption key to unlock the media content. The publisher's remote server that receives the request to unlock the media content will then verify payment information that is on file from the user and, once verified, will charge the user a transaction fee for this request (step 416). If the request to unlock the media is approved the publisher of the media, the remote server 304 will then transmit the code string or key to the media device 100 (step 318) and then the processing module 120 will process this string or key using standard computer processing power and the encryption software instructions or digital rights management instructions store in the encryption module 128 to unlock the digital stored media content (step 420). The user will then have access to the whole file and may play the media content (step 422). If the transaction is denied or refused, the server will deny a subsequent request of the user for a new selection of media content.

In another embodiment of the present disclosure, the user will input the payment information from a keyboard, via voice recognition, a credit card scanning device, or other types of input devices that currently exist or will exist in the future to the media device 100. For example, the device may include a scanning module 132 for reading account information from a conventional debit or credit card. The media device will then transmit this information via the communication module 112 from the device to the publisher along with the request to unlock the media content. The publisher will receive this information at the publisher's remote server and will then verify payment and once verified charge the user for this request. If the request to unlock the media content is approved, the publisher of the media will then transmit the code string and/or key that will go the processing module 120 of the media device and then the processing module 120 will process this code string using standard computer processing power and the encryption software instructions to unlock the digital stored media content. Once the digital media content is unlocked, the user would be able to play the media content by using basic player software that is built into the digital player device (step 422).

In another embodiment, the device 100 will communicate to the remote server 304 for transmitting the first request for a selection of media content and for receiving the various selections of media content without being coupled to the local processor or terminal 310. The communication module 112 will in addition to transmitting the request to unlock the media content will directly transmit user selections for media content to the remote server and will receive the selections of media content through the various wireless protocols listed above.

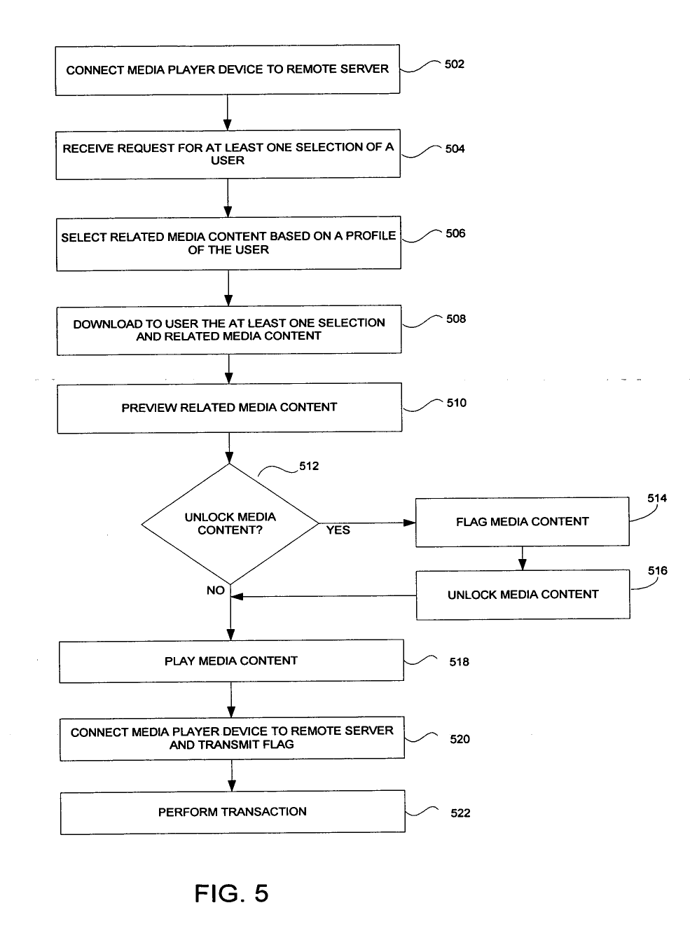

Referring to FIG. 5, another method for delivering media content to a user is illustrated. A user connects the media player device 100 to a local processor assembly, e.g., terminal 310, to download media content via wireless or wired communications protocols remote storage medium 306 of remote server 304 on the global computer network, e.g., the Internet, to the device 100 (step 502). When the user is connected to a remote server site (e.g., a website residing on server 304), the user will be able to select various types of media content to be downloaded to the device 100, e.g., movies, music, computer games, etc. Once the selections are made by the user, a request will be sent to the remote server 304 for processing (step 504). Once the server 304 receives the request from the user, the server will select related media content to be delivered to the user based on a profile of the user (step 506). This selection of media content will be based on profiling the user to determine which media content the user might be interested in as described above. As described above, the related media content, or second selection of media content, may be media content the remote server, e.g., publisher/distributor, wants to expose the user to without using the user profile as the determinative factor.

Once the related selections are determined, a publisher or distributor of the media (such as iTunes, Rhapsody or Napster) would then download media content that the user has selected and the related media content to the internal or removable digital storage module 110 of the device 100 (step 508). Once the user has received this digital media content, the user will be able to preview the related media by using basic player software that is built into the digital player device (step 510).

When the user wishes to play the locked media content, the user will inform the processing module 120 via the input module 106 that he wishes to access this media content. The processing module 120 will write a mark or flag or another indication on the internal or removable memory storage that the user will be accessing the locked media (step 514). This flag/mark/indication will not be able to be rewritten by the user to avoid later payment. Preferably, the flag/mark/indication will be encrypted by the encryption module 128. Once written, the processing module will instruct the encryption module 128 to unlock the media content (step 516). The digital media content may be encrypted with any type of current encryption algorithms as described above. Once the digital media content is unlocked, the user would be able to play the media content by using basic player software that is built into the digital player device 100 (step 518).

When the user wishes to download more media content, the user will connect the media player device 100 to a local computer processor assembly to download media content via wireless or wired protocols from the remote storage medium 306 (step 520). When the user is connected to the remote server site 304, the remote server, e.g., publisher or distributor of the media such as ITunes, Rhapsody or Napster, would then read the flag/mark/indication on the user's media device and then using standard e-commerce software protocols, institute a payment transaction for the user to pay a transaction fee for the media content that the device indicates was unlocked (step 522). Once this transaction is approved, the processing module 120 will write to the internal or external memory storage module 110 an instruction indicating that the unlocked media has been paid for. Alternatively, if the transaction is denied, the user will not be able to perform subsequent downloads.

Optionally, the device 100 may include a user verification module 130 for verifying an identity of the user of the device. In this embodiment, the processing module 120 will interact with the user verification module 130 and only allow authorized users to access locked media to prevent unauthorized charges to the account of the owner.

In a further embodiment, the portable media device 100 will also incorporate a broadcast tuner(s) to receive broadcasts from AM, FM or satellite radio stations and to store these broadcasts on the storage module 110. Referring back to FIGS. 1 and 2, the device will include an antenna ANT for receiving broadcast signals and a tuner module 122 for tuning the antenna ANT to a signal frequency and demodulating the received signals. In this embodiment, the user will be able to preview media that will be transmitted to the media device via broadcast channels (e.g., FM, AM, Satellite broadcast such as XM Radio or Sirius). This previewed media would be transmitted and received on one broadcast channel. The user will be able to preview the media by using basic player software that is built into the digital player device. The user will then be able to unlock the media as described in the various embodiments above.

It is to be appreciated that although the above embodiments describe media player software built into the device, future versions of the player software and different types of player software may be downloaded to the device and stored in the storage module. The processing module will then interact with the storage module to access these other types of media players. It is also to be understood that several different types of media player software may reside concurrently on the device 100 each one being executed independently when required by the media content file type.

It is also to be appreciated that the remote server, e.g., the publisher/distributor, may transmit unlocked media content in addition to the locked media content or may transmit only unlocked media content to the user where the remote server wants to expose users to the unlocked media content. In this situation, the remote server will push to the user or the portable device described above unlocked media content that is fully playable without restrictions, e.g., a new song from a new unknown artist, a preview of an independent film, etc. It is further to be appreciated that this unlocked media content may not be based on a profile of the user but that the remote server has determined that the media content is to be exposed to a large audience.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for delivering media content to a user over a computer network, the method comprising the steps:
receiving a first request for at least one selection of media content;
selecting at least one second selection of media content based a profile of the user; and
transmitting to the user the at least one selection of media content and the at least one second selection of media content, wherein a portion of the at least one second selection of media content is locked to prevent user access.

2. The method as in claim 1, further comprising the steps:
receiving a second request to view the locked portion of the at least one second selection of media content; and
transmitting to the user a code for unlocking the locked portion of the at least one second selection of media content.

3. The method as in claim 2, further comprising the step charging a transaction fee to an account of the user for unlocking the at least one second selection of the media content.

4. The method as in claim 2, wherein the second request includes payment information of the user, further comprising the step charging the user to unlock the locked portion of the at least one second selection of media content.

5. The method as in claim 3, wherein the at least one second selection includes a preview of the locked media content.

6. The method as in claim 1, further comprising the steps:
receiving an indication the user accessed the locked portion of the at least one second selection of media content; and
charging a transaction fee to an account of the user for unlocking the at least one second selection of the media content.

7. The method as in claim 6, wherein upon approval of the charging step, transmitting the approval to the user.

8. The method as in claim 6, wherein if the charging step is refused, denying a subsequent request of the user for a new selection of media content.

9. The method as in claim 2, wherein the locked portion of the at least one second selection of media content is encrypted.

10. The method as in claim 9, wherein the code for unlocking is a decryption key.

11. The method as in claim 2, wherein the user profile includes psychographics, demographics, and past purchase/usage habits of the user.

12. A method of delivering media content to a user over a computer network, the method comprising the steps:
broadcasting at least one selection of media content over a broadcast channel, a portion of the at least one selection is locked to prevent user access;
receiving a request to access at the locked portion of the at least one selection of media content; and
transmitting a code for unlocking the locked portion of the at least one selection of media content.

13. The method as in claim 12, further comprising the step charging a transaction fee to an account of the user for unlocking the at least one selection.

14. The method as in claim 12, wherein the request includes payment information of the user, further comprising the step charging the user to unlock the locked portion of the at least one selection of media content.

15. The method as in claim 12, wherein the at least one selection includes a preview of the locked media content.

16. The method as in claim 12, further comprising the steps:
receiving an indication the user accessed the locked portion of the at least one selection of media content; and
charging a transaction fee to an account of the user for unlocking the at least one selection of the media content.

17. A device for playing media content, the device comprising:
a display module configured to display video and image media content and to produce audio media content;
a communication module configured to receive at least one selection of media content, a portion of the at least one selection is locked to prevent user access;
an input module configured to input user instructions to indicate a request to access the locked media content; and
a processing module configured for receiving the user instructions and for unlocking the locked media content.

18. The device as in claim 17, wherein the processor is further configured to flag the unlocked media content and transmit the flag to the communication module for submission to a remote server for purchasing the unlocked media content.

19. The device as in claim 18, further comprising an encryption module for encrypting the flag.

20. The device as in claim 17, wherein the processor is configured to transmit the request to the communication module for submission to a remote server for purchasing a code to unlock the locked media content.

21. The device as in claim 20, wherein the input module is further configured to input payment information for purchasing the code.

22. The device as in claim 20, further comprising a tuner module for receiving media content over a broadcast channel.

23. A system for delivering media content to a user comprising:
at least one device for playing media content comprising:
a display module configured to display video and image media content and to produce audio media content;
a communication module configured to transmit a first request for at least one selection of media content to a server; and
a processing module configured for playing the at least one selection of media content;
the server configured for receiving the first request for at least one selection of media content, selecting at least one second selection of media content based a profile of the user and transmitting to the at least one device the at least one selection of media content and the at least one second selection of media content, wherein a portion of the at least one second selection of media content is locked to prevent user access; and
a communications network for coupling the at least one device to the server.

24. The system as in claim 23, wherein the at least one device further includes an input module configured to input user instructions to indicate a second request to access the locked media content and the server further configured to receive the second request to access the locked portion of the at least one second selection of media content and transmit to the at least one device a code for unlocking the locked portion of the at least one second selection of media content.

25. The system as in claim 24, wherein the server is further configured to charge a transaction fee to an account of the user for unlocking the at least one second selection of the media content.

26. The system as in claim 24, wherein the second request includes payment information of the user and the server is further configured to charge the user to unlock the locked portion of the at least one second selection of media content.

27. The system as in claim 25, wherein the second selection includes a preview of the locked media content.

28. The system as in claim 23, wherein the processor module marks an indication that the locked portion of the media content has been accessed and the communication module transmits the indication to the server and wherein the server is configured to receive the indication the user accessed the locked portion of the at least one second selection of media content and to charge a transaction fee to an account of the user for unlocking the at least one second selection of the media content.

29. The system as in claim 24, wherein the locked portion of the at least one second selection of media content is encrypted.

30. The system as in claim 29, wherein the code for unlocking is a decryption key.

31. The system as in claim 23, wherein the user profile includes psychographics, demographics, and past purchase/usage habits of the user.

32. A method for delivering media content to at least one device over a computer network, the method comprising the steps:
receiving a first request for at least one selection of media content;
selecting at least one second selection of media content; and
transmitting to the at least one device the at least one selection of media content and the at least one second selection of media content.

33. The method as in claim 32, wherein the selecting step further comprises selecting the at least one second selection of media content based on a profile of a user of the at least one device.

34. The method as in claim 33, wherein the user profile includes psychographics, demographics, and past purchase/usage habits of the user.

35. The method as in claim 32, wherein the at least one second selection is a preview of at least one third selection of media content.

36. The method as in claim 32, wherein the at least one device comprises:
an input module configured to input user instructions to indicate the first request;
a communication module configured to transmit the first request and receive the at least one first and second selection of media content;
a display module configured to display video and image media content and to produce audio media content; and
a processing module configured for receiving the user instructions, transmitting the received instructions to the communication module, and playing the at least one first and second selection of media content.

37. The method as in claim 36, wherein the at least one device is portable.
